(19) United States
(12) Patent Application Publication
(10) Pub. No.: US 2008/0151288 A1
(43) Pub. Date: Jun. 26, 2008

(54) Document processing system, document processing instruction apparatus, computer readable recording medium storing document processing program, and computer data signal embodied in carrier wave

(75) Inventor: Junichi Matsunoshita, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/797,469

(22) Filed: May 3, 2007

(30) Foreign Application Priority Data
Dec. 26, 2006 (JP) 2006-350347

(51) Int. Cl. G06F 3/12

(52) U.S. Cl. 358/1.15

(57) ABSTRACT

A document processing system, which includes: a document processing instruction apparatus that instructs on processing of a document; a management apparatus that manages, corresponding to the document, a processing condition for the document; and one or plural printing apparatuses that prints the document; in which the document processing instruction apparatus includes: an acquisition section that acquires the processing condition for the document related to the instruction from the management apparatus; an extraction section that, when the instruction of the processing is instruction of printing processing, extracts, from the one or plural printing apparatuses, a printing apparatus having a function of printing under a printing condition included in the acquired processing condition; a selection receiving section that receives selection of a desired printing apparatus from the extracted printing apparatus; and a printing instruction section that instructs on printing under the printing condition for the selected printing apparatus.

### CROSS-REFERENCE TO RELATED APPLICATION

This application is based on and claims priority under 35 USC 119 from Japanese Patent Application No. 2006-350347 filed on Dec. 26, 2006.

### BACKGROUND

1. Technical Field

The present invention relates to a document processing system, a document processing instruction apparatus, a computer readable recoding medium storing a document processing program, and a computer data signal embodied in a carrier wave.

2. Related Art

There has been proposed an art for preventing duplication of a confidential document without permission.

In addition, a multifunction machine, and the like, have been proposed which extract information with a pattern image embedded in an image of a scanned document, and when the information indicates identification information of the document, for example, notify the policy server of the identification information for the document for copying according to the security level which has been set for the document, or controlling the image reading processing.

By the way, some multifunction machines do not have the above-mentioned code embedding function. If, in the user's terminal, only the driver for a multifunction machine which does not have the code embedding function is installed, the document will be printed by the multifunction machine without the code being embedded.

### SUMMARY

According to an aspect of the invention, there is provided a document processing system, which includes a document processing instruction apparatus that instructs on processing of a document; a management apparatus that manages, corresponding to the document, a processing condition for the document; and one or plural printing apparatuses that carry out printing of the document; in which the document processing instruction apparatus includes: an acquisition section that acquires the processing condition for the document related to the instruction from the management apparatus; an extraction section that, when the instruction of the processing is instruction of printing processing, extracts, from the one or plural printing apparatuses, a printing apparatus having a function of printing under a printing condition included in the processing condition acquired by the acquisition section; a selection receiving section that receives selection of a desired printing apparatus from the printing apparatus extracted by the extraction section; and a printing instruction section that instructs on printing under the printing condition for the printing apparatus selected by the selection receiving section.

### BRIEF DESCRIPTION OF THE DRAWINGS

An exemplary embodiment of the present invention will be described in detail based on the following figures, wherein:

FIG. 1 is a diagram showing an example of configuration of a document processing system of the present invention;

FIG. 2 is a diagram showing a printing image of a background image which is synthesized into a document image for which the security level 2 is set;

FIG. 3 is a diagram showing a printing image of a background image which is synthesized into a document image for which the security level 3 is set;

FIG. 4 is a diagram showing a printing image of a background image which is synthesized into a document image for which the security level 4 is set;

FIG. 5 is a block diagram showing an example of respective configurations of a client terminal, a multifunction machine, a policy server, a document management server, and a printer;

FIG. 6A and FIG. 6B are diagrams showing examples of registration contents of security document management information;

FIG. 7 is a diagram showing an example of setting of the document management policy;

FIG. 8 is a diagram showing an example of printer management information;

FIG. 9 is a flowchart showing an example of display processing of a security document;

FIG. 10 is a flowchart showing an example of printing processing of a security document;

FIG. 11 is an example of extracted image of printers which are capable of printing a document for which security levels are set; and

FIG. 12 is a flowchart showing an example of duplication processing of a printing document by a multifunction machine as shown in FIG. 1.

### DETAILED DESCRIPTION

An exemplary embodiment of the present invention will be described with reference to the attached drawings.

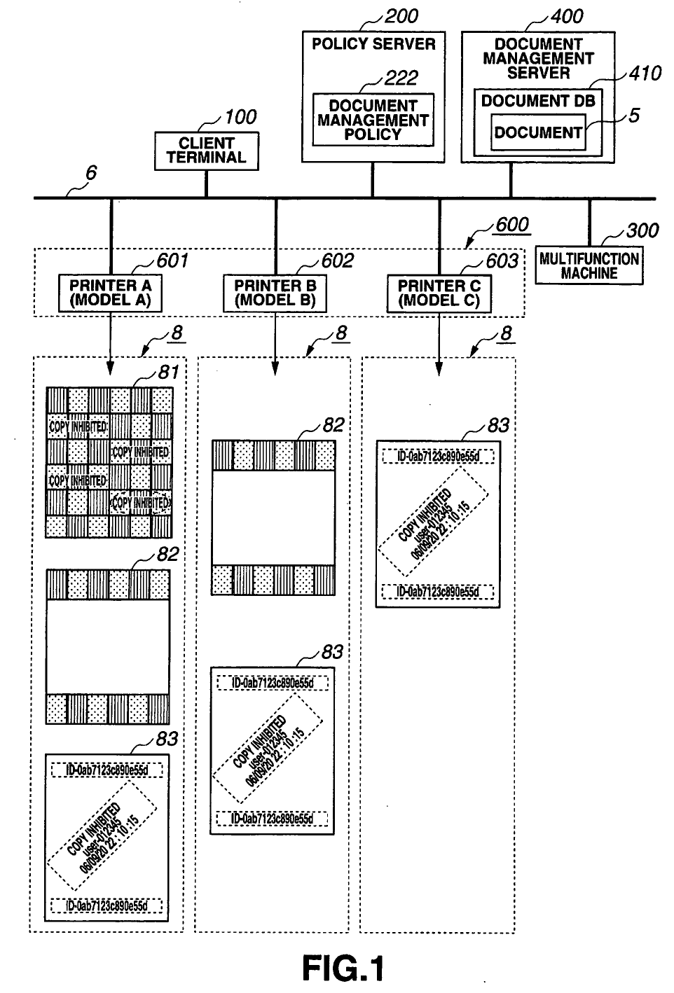

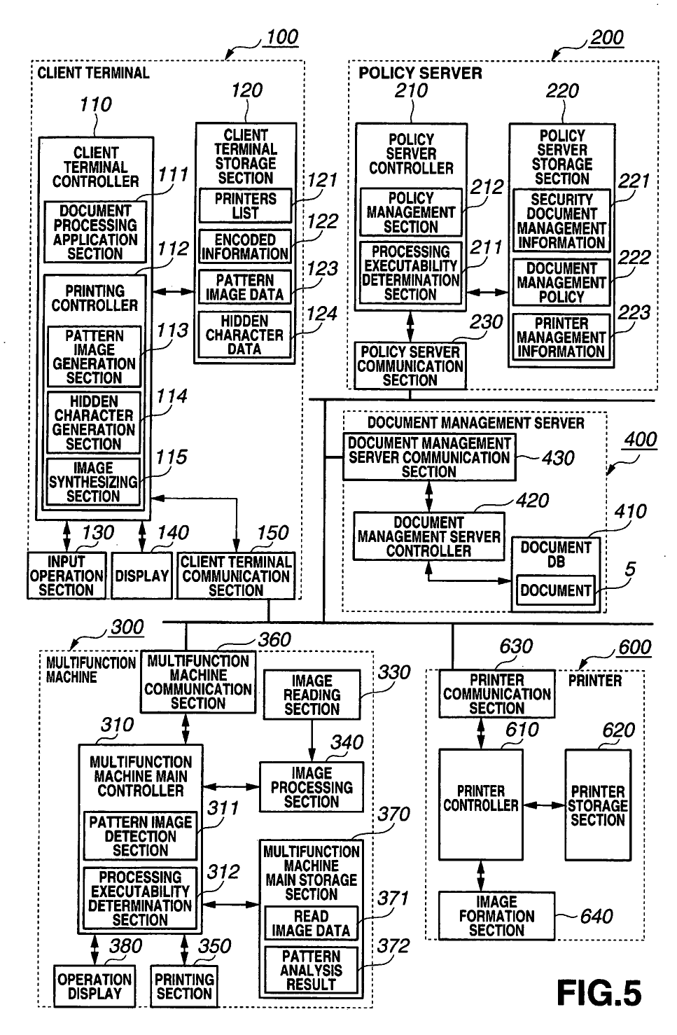

FIG. 1 is a drawing illustrating one example of configuration of a document processing system of the present invention, and FIG. 5 is a drawing illustrating one example of configuration of a client terminal, a multifunction machine, a policy server, a document management server, and a printer.

In FIG. 1, a document processing system 10 is configured to provide a document management server 400 that registers a document 5 to a document data base 410 (hereinafter referred to as “document DB”) for managing the document 5; a policy server (management apparatus) 200 that sets a security level for the document 5, determines whether processing of the document 5 for which the security level is set is possible, and decides, if the processing of the document 5 is possible, a processing condition (including the printing condition), on the basis of a document management policy 222 that sets and stores processing conditions for each particular combination of the security level set for the document 5 with a type of processing; a client terminal (a document processing instruction apparatus ) 100 that, according to the security level set for the document 5, carries out printing processing, to a printer (a printing apparatus) 600, of a printing document (81 in FIG. 1, 82 in FIG. 1) in which encoded information indicating copying inhibition information or document identification information (hereinafter referred to as “document ID”) using the pattern image is embedded in the background; and a multifunction machine 300 that, according to the security level set for the document 5, inquires of the policy server 200 whether copying processing or image reading processing of a printing document 8 is executable, and on the basis of the result of the inquiry, carries out processing. In the document processing system 10, the document management server 400, the policy server 200, the client terminal 100 and the multifunction machine 300 are connected each other through a network 6.

As shown in FIG. 1 and FIG. 5, when a user carries out a display operation for the document 5 on the client terminal 100, the client terminal 100 notifies the policy server 200 of the document ID of the document 5 specified by the user, and inquires thereof whether display of the document 5 is possible. When the document 5 is a displayable document, the client terminal 100 reads out the document data from the document DB 410, and displays the contents of the document on a display 140 of the client terminal 100.

The client terminal 100 has a printer list extraction function in which, when a printing instruction operation for the document 5 for which a security level is set is detected, a list of printers 600 from which the user can specify is displayed on the display 140 of the client terminal 100. Additionally, the client terminal 100 has a function in which, when a security level is set for the document 5 for which the printing instruction is given, the encoded information is embedded in the background using the pattern image as a printing condition corresponding to the security level set for the document 5 for which printing instruction is made, and also has a function in which only printer 600 that has a printing function, such as printing of hidden characters, is extracted.

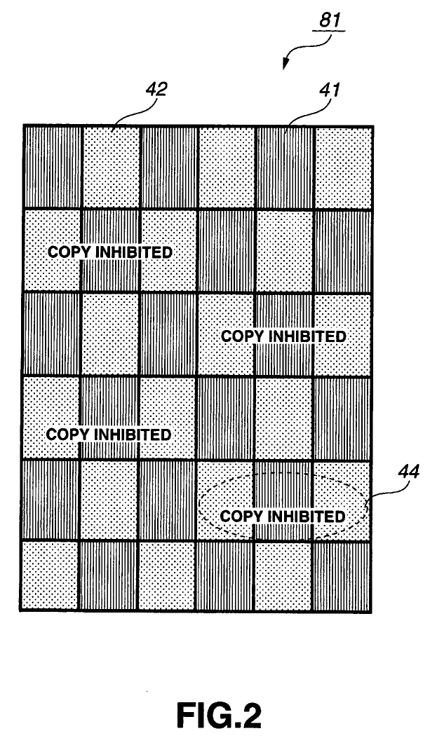

For example, in FIG. 1, when the printing condition for the security level of the target document 5 is set to a function of printing the pattern image for embedding the encoded information in the document 5 (41 in FIG. 2, 42 in FIG. 2), and a function of printing a hidden character that become visible at the time of printing on the background (44 in FIG. 2), only the printer A (601) of a model A is extracted, among a printer A (601), a printer B (602), and a printer C (603) which are specifiable from the client terminal 100, as a printer 600 which the user can select because this printer can realize the two functions.

When an operation of copying, scanning, or facsimile transmission is carried out on the printing document 8 on which the document 5 for which the security level is set is printed, the multifunction machine 300 analyzes the read image data of the printing document 8, and carries out detection processing of the pattern image for extraction of encoded information 122.

The pattern image is detected from the read image data of the printing document 8 and from the encoded information embedded in the pattern image, the duplication inhibition code or the document ID are decoded.

When, by decoding the encoded information, the document ID can be acquired, the document ID and the type of processing for the document 5 (copying or scanning) are notified to the policy server 200 for inquiring thereof whether processing of the printing document 8 is possible, and when processing of the printing document 8 is not permitted, the processing of the printing document 8 is halted.

When, by decoding the encoded information, the duplication inhibition code can be acquired, processing of the printing document 8 is halted on the determination of the multifunction machine 300 alone without inquiring of the policy server 200.

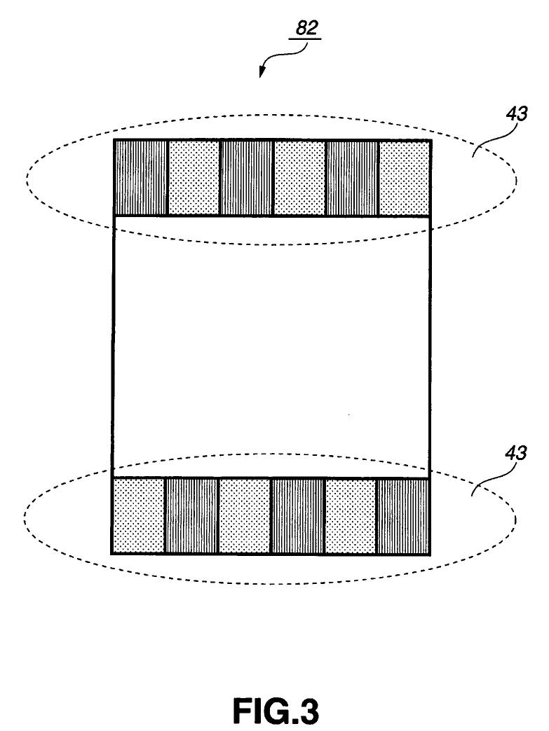

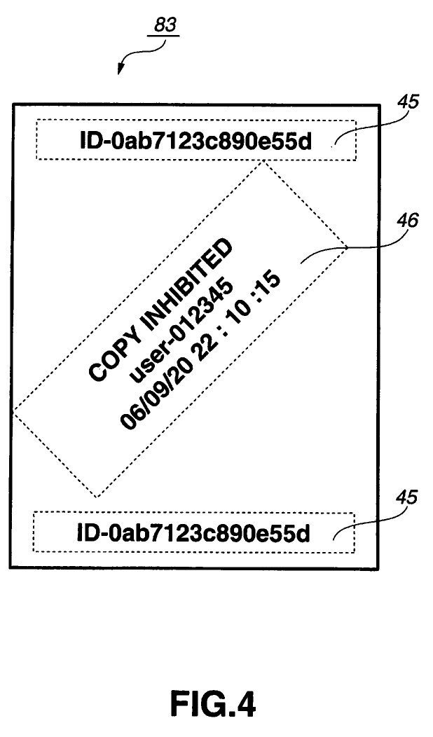

Examples of output of the printing document 8 under the printing condition according to the security level will be described as follows. When four stages of security level can be set, for the remaining three security levels excluding the security level 1 which inhibits printing processing of the document 5, one example of the security level 2 is shown in FIG. 2, one example of the security level 3 is shown in FIG. 3, and one example of the security level 4 is shown in FIG. 4, in the descending order of protection level.

FIG. 2 is a diagram illustrating the printing image under the printing condition for the document 5 with the security level 2.

In the printing document (81 in FIG. 2) which is printed under the printing condition of the security level 2, as two different types of pattern image that are disposed in the form of mosaic tiles over the entire paper surface on a prescribed rule, one type of pattern image (41 in FIG. 2) in which a duplication inhibition pattern for embedding the duplication inhibition code is embedded, and the other type of pattern image (42 in FIG. 2) in which the document ID of the printed document and the inherent sheet number provided for identifying the printed document is embedded, being coded, are embedded, and further a hidden character printing region (44 in FIG. 2) where characters which become visible in copying is embedded as hidden characters is given.

FIG. 3 is a diagram illustrating the printing image under the printing condition for the document 5 with the security level 3.

In the printing document (82 in FIG. 3) which is printed under the printing condition of the security level 3, the pattern image as shown in FIG. 2 is printed in a part of the region including the top or bottom of the paper rather than on the entire surface of the paper.

However, as compared to the pattern image printed in the printing document of the security level 2 as shown in FIG. 2, the pattern image having a larger size is printed.

FIG. 4 is a diagram illustrating the printing image under the printing condition for the document 5 with the security level 4.

With the printing document (83 in FIG. 4) which is printed under the printing condition of the security level 4, embedding processing of the encoded information 122 with the pattern image is not carried out, and a character image indicating the document ID and the sheet number of the printing document 8, and the like, as the encoded information 122 as shown in FIG. 2 or FIG. 3 is printed in the empty region of the document (45 in FIG. 4), with a visible character image, such as “copying inhibition”, or the like, (46 in FIG. 4) being printed in the background.

When a document which is printed in the form of the security level 4 which provides the printing document 8 in which a background image having no pattern image is printed is subjected to copying or scan processing by the multifunction machine 300, the determination processing in liaison with the policy server 200 about whether the processing is executable, or the copying inhibition control on the basis of detection of a copying inhibition pattern will not be carried out.

Next, respective examples of configuration of the client terminal 100, the policy server 200, the multifunction machine 300, the document management server 400, and the printer 600 will be described with reference to a block diagram in FIG. 5.

### (Client Terminal)

The client terminal 100 includes: a client terminal controller 110 that is realized by implementing a program using a CPU (Central Processing Unit) to control the entire client terminal 100; a client terminal storage section 120 that is realized by a RAM (Random Access Memory), a ROM (Read Only Memory) or other memory element as well as a hard disc, etc., holds the program implemented by the CPU (Central Processing Unit) and functions as a work memory that stores various data used during each program processing; a client terminal communication section 150 that is realized by an LAN (Local Area Network) connecting board or other circuit-terminating equipment; a input operation section 130; and a display 140. The client terminal storage section 120, the client terminal communication section 150, the input operation section 130 and the display 140 are connected to the client terminal controller 110.

The client terminal control section 110 has a document processing application section 111 and a printing control section 112 as functional blocks for carrying out display processing of the document 5 on the basis of the security level and printing processing of the document 5 for the multifunction machine 300.

When the document processing application section 111 detects display operation for the document 5 or printing operation for the document by the input operation section 130 on the document operation screen displayed in the display 140, the document processing application section 111 acquires the type of processing for the document 5 and the document ID of the document 5 to be processed by analyzing the input operation, and sends data including the type of processing and the document ID which is acquired, to the policy server 200 through a client terminal communication section 150 for inquiring thereof whether processing of the document 5 is executable.

The printing control section 112 performs a printing control which, upon request from the document processing application section 111, receives the data of the document 5 to be printed; prepares the printing data for printing the printing document 8 on the multifunction machine 300; and outputs the prepared printing data to the multifunction machine 300 through the client terminal communication section 150. Additionally, when printing control of the document for which the security level is set is to be carried out, the printing control section 112 has a pattern image generation section 113, a hidden character generation section 114, and an image synthesizing section 115 as functional blocks for embedding the encoded information 122 including the document ID of the document 5 to be printed in the background of the printing document 8 using the pattern image.

The pattern image generation section 113 prepares a document ID embedded image 42 or a duplication inhibition code embedded image 41 to be embedded in the background image with the pattern image, and saves the prepared pattern image data 123 in a client terminal storage section 120.

The hidden character generation section 114 prepares data 124 in which information about the hidden characters which are to be embedded in the background image of the printing document 8, and with which a character image, such as “Duplication inhibited”, or the like, is made visible in copying the image of the printing document 8 is recorded.

The image synthesizing section 115 prepares printing data in which a drawing instruction for synthesizing a background image including the pattern image prepared in the pattern image generation section 113 and the hidden characters prepared in the hidden character generation section 114 into the image of the document 5 to be printed is described in a printer description language which is analyzable by the multifunction machine 300.

### (Policy Server 200)

The policy server 200 includes: a policy server control section 210 that is realized by the CPU (Central Processing Unit) implementing the program to control the entire policy server 200; a policy server storage section 220 that is realized by memory devices, such as an RAM (Random Access Memory), an ROM (Read Only Memory), and the like, as well as a hard disk, and the like, and stores information about the security policy (the processing conditions) and information about the security level of the document; and, a policy server communication section 230 that is realized by a circuit-terminating equipment, such as an LAN (Local Area Network) connection board, or the like, and controls the data communication with the client terminal 100 and the multifunction machine 300 connected through the network 6. The policy server storage section 220 and the policy server communication section 230 are connected to the policy server control section 210 through the bus.

The policy server storage section 220 is realized by memory devices, such as an RAM (Random Access Memory), an ROM (Read Only Memory), and the like, as well as a hard disk, and the like; holds programs which are implemented by the CPU (Central Processing Unit); operates as a working memory for holding various data to be utilized in the course of processing of the respective program; and stores a security document management information 221, a document management policy 222, and a printer management information 223.

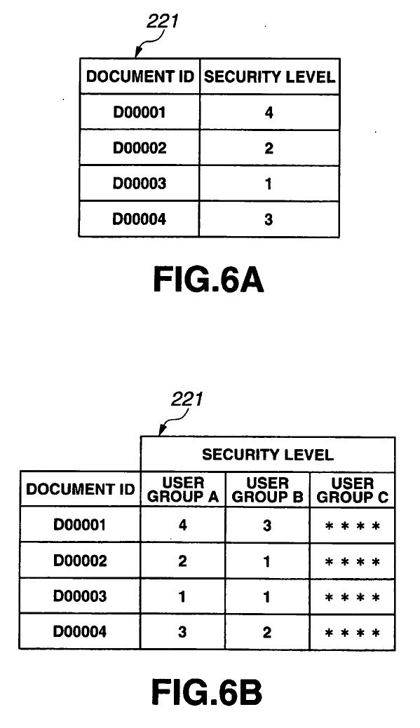

As shown in FIG. 6A, the security document management information 221 provides data in the form of a table in which the document ID of the document 5 that is registered in the document DB 410 and the value of the security level set for the document corresponding to the document ID are recorded, and is managed by a policy management section 212.

As shown in FIG. 6B, the security level for the document 5 may be set at a different security level and managed by each particular user, or otherwise, user group operating the document 5.

The document management policy 222 provides matrix data in which, for each combination of the security level of the processing object document with the type of processing for the document, inhibition or permission of the processing is set and recorded, respectively, and is managed by the policy management section 212.

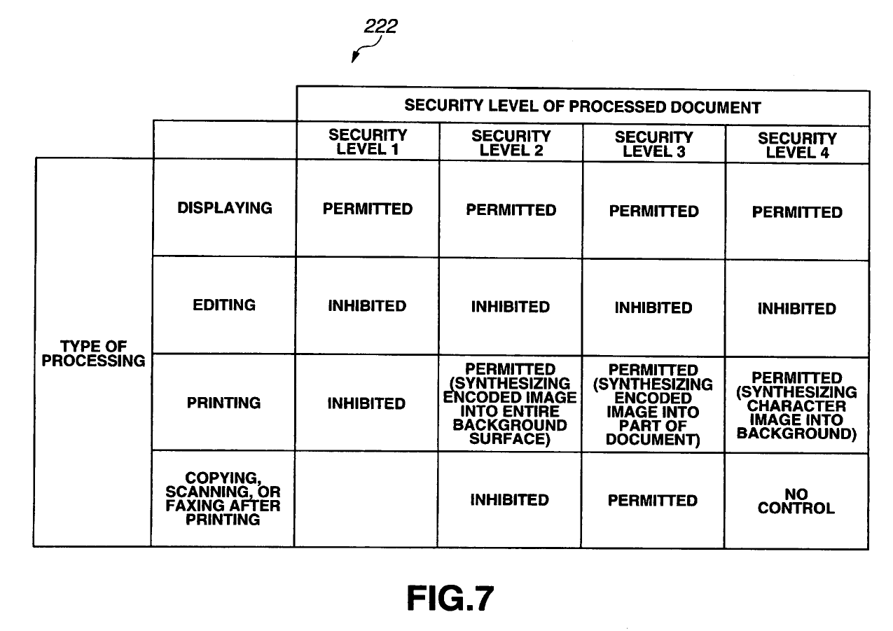

As an example of the document management policy 222, as shown in FIG. 7, for example, the security levels set for the document are provided as security level 1, security level 2, security level 3, and security level 4, in the descending order of protection level; as the types of processing for the document 5, four types, i.e., “display”, “editing”, “printing”, “copying, scanning, or faxing after document printing” are provided; and for each combination of the security level with the type of processing, “permission” or “inhibition” of the processing is set.

It is indicated, for example, that, for the document of the security level 2, “copying, scanning, or faxing after printing” is inhibited for processing, while, for the document of the security level 3, “copying, scanning, or faxing after printing” is possible.

The printer management information 223 provides matrix data for registering and managing of models of the printer 600 (a multifunction machine) which is connected to the network 6 and prints the document 5, and recording and managing whether, for each model registered, printing is possible at each particular security level for which the printing processing set by the document management policy 222 is permitted, and is managed by the policy management section 212.

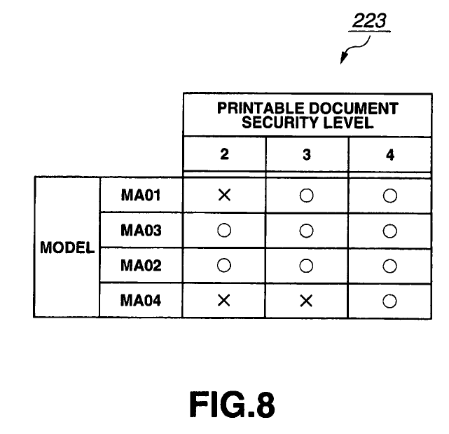

FIG. 8 is a drawing giving one example of the printer management information 223, which indicates that the printing apparatus of model “MA 03” is an apparatus corresponding to the document printing which synthesizes a background image defined for the security levels 2 to 4, and indicates that the printing apparatus of model “MA 04” is an apparatus corresponding to the document printing which synthesizes a background image defined for the lowest security level 4.

The policy server control section 210 has a policy management section 212 and a processing executability determination section 211 as functional blocks for determining whether the processing is executable, on the basis of the security policy for the document 5.

When the processing executability determination section 211 receives inquiry data including the document ID and the type of processing that is notified from the client terminal 100 or the multifunction machine 300 through the policy server communication section 230, the processing executability determination section 211 references the security document management information 221 with the document ID included in the received data, and identifies the security level of the document.

In addition, the processing executability determination section 211 references the document management policy 222 with the security level identified and the type of processing that is recorded in the received data for determining whether the processing of the document 5 is executable.

### (Multifunction Machine 300)

The multifunction machine 300 includes: a multifunction machine main control section 310 that is realized by the CPU (Central Processing Unit) implementing the program to control the entire multifunction machine 300; an image reading section 330; an image processing section 340; a printing section 350; a multifunction machine communication section 360 that is realized by a circuit-terminating apparatus, such as an LAN (Local Area Network) connection board, or the like; and a multifunction machine main storage section 370 that is realized by memory devices, such as an RAM (Random Access Memory), an ROM (Read Only Memory), and the like, as well as a hard disk, and the like, that holds programs implemented by the CPU (Central Processing Unit), and that operates as a working memory for holding various data to be utilized during processing of the program. The image reading section 330, the image processing section 340, the printing section 350, the multifunction machine communication section 360 and the multifunction machine main storage section 370 are connected to the multifunction machine main control section 310.

The image processing section 340 receives read data which is the image of the printing document 8 outputted from the image reading section 330 that is read with a prescribed resolution; carries out image correction processing (automatic upright correction, noise rejection, and the like) for the image reading data received; and saves the processed image data in the multifunction machine main storage section 370 as read image data 371.

The multifunction machine main control section 310 has not only the functions of the conventional multifunction machine, such as the image reading function for the printing document 8 by the image reading section 330; the copying function of printing the copying image of the printing document 8 on the basis of the read image data 371 read out by the image reading section 330, using the printing section 350; and the printing function for the printing document 8 on the basis of the printing data for the document 5 that is received from the client terminal 100 through the multifunction machine communication section 360, using the printing section 350, but also a pattern image detection section 311 and a processing executability determination section 312 as the functional blocks for determining whether copying, scanning, or faxing of the printing document 8 after the document 5 for which the security level is set being printed is possible on the basis of the security policy which is managed by the policy server 200; or for determining whether duplication of the printing document 8 with its own apparatus is executable, on the basis of whether there is the pattern image indicating copying inhibition.

The pattern image detection section 311 carries out detection processing of the pattern image in the read image data 371 which is stored in the multifunction machine main storage section 370, and when the pattern image is detected, the pattern image detection section 311 transforms the encoded information 122 which is embedded in the read image, into a two-dimensional code arrangement on the basis of the pattern image, and saves the document ID which is embedded as the encoded information 122, in the multifunction machine main storage section 370 as a pattern analysis result 372.

The processing executability determination section 312 detects the copying, scanning, or faxing operation of the printing document 8 by the operation display 380 for discriminating the type of processing, and discriminating whether the operation mode which is recorded in the multifunction machine main storage section 370 is the policy server liaison mode in which whether the processing is executable is determined according to the security policy in liaison with the policy server 200, or the operation mode in which whether the processing is executable is determined on the basis of whether the pattern image indicating duplication inhibition is given.

When the operation mode is the policy server liaison mode, the processing executability determination section 312 sends the pattern analysis result 372 which is given by the pattern image detection section 311, and the type of processing of copying, scanning, or faxing to the policy server 200 through the multifunction machine communication section 360 for inquiring thereof whether the processing for the type of processing which is sent is executable, and on the basis of the determination result by the policy server 200, determines whether the processing of scanning or copying of the printing document 8 is to be continued or halted.

When the operation mode is not the policy server liaison mode, the processing executability determination section 312 determines whether the pattern image indicating duplication inhibition is detected by the pattern image detection section 311, by referencing the pattern analysis result 372, and when the pattern image indicating duplication inhibition is detected, halts the copying, scanning, or faxing processing of the printing document 8.

### (Document Management Server 400)

In the document management server 400, a document management server control section 420 is realized by the CPU (Central Processing Unit) implementing the program; controls registering and updating the document 5 for the document DB 410 and reading the registered data for the document 5 from the document DB 410 on the basis of the processing instruction for the data base that is received through the document management server communication section 430; and sends the processing result for the document DB 410 to the apparatus that accesses the document DB 410.

### (Printer 600)

The printer 600 includes: a printer control section 610 that is realized by the CPU (Central Processing Unit) implementing the program to control the entire printer 600, a printer communication section 630 that is realized by a circuit-terminating apparatus, such as an LAN (Local Area Network) connection board, or the like, and carries out data communication for printing control including the printing data through the network 6 between it and the client terminal 100; a printer storage section 620 that is realized by memory devices, such as an RAM (Random Access Memory), an ROM (Read Only Memory), and the like, as well as a hard disk, and the like, holds programs implemented by the CPU (Central Processing Unit), and operates as a working memory for holding various data to be utilized during the printing processing; and, an image formation section 640 that transfers the page image of the document 5 to a paper for printing. The printer communication section 630, the printer storage section 620 and the image formation section 640 are connected to the printer control section 610 through the bus.

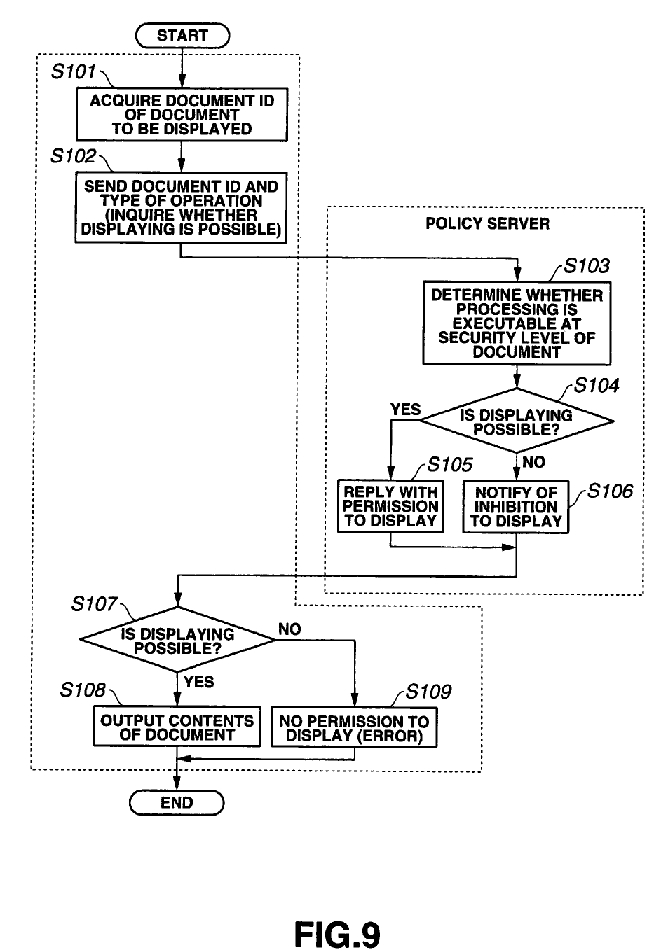

Next, the display processing of the document 5 for which the security level is set by the policy server 200 will be described with reference to the flowchart in FIG. 9.

The document processing application section 111 detects the display operation for the document on the document processing screen displayed in the display 140 by the input operation section 130 for identifying the document ID of the document 5 to be displayed (S101).

The document processing application section 111 sends the document ID and the type of processing (the display processing of the document) to the policy server 200 through the client terminal communication section 150 for inquiring thereof whether the processing is executable (S102).

The policy server 200 references the security document management information 221 with the document ID which is notified from the client terminal 100 for acquiring the security level for the document 5 corresponding to the document ID, and the processing executability determination section 211 references the document management policy 222 with the document ID and the type of processing which is received from the client terminal 100, for determining the permission or inhibition of the processing (S103).

When the display processing of the document 5 is permitted (YES S104), the processing executability determination section 211 prepares reply data permitting the display processing of the document 5, and to the document processing application section 111 of the client terminal 100, sends the reply data through the policy server communication section 230 (S105).

When the document 5 to be displayed is encoded by the document DB 410, key information for decoding the encoded document 5 is also sent.

When the display processing of the document 5 is inhibited (NO at S104), the processing executability determination section 211 sends reply data inhibiting the display processing of the document 5 to the document processing application section 111 of the client terminal 100 through the policy server communication section 230 (S106).

The document processing application section 111 analyzes the reply data which is received from the policy server 200; when the display processing of the document is permitted (YES at S107), the document processing application section 111 accesses the document DB 410 for reading the data for the document 5; and further when the encoded data for the document 5 is received from the policy server 200, the data for the document 5 is decoded with the decoding key for outputting the contents of the document to the display 140 (S108).

On the other hand, when the display processing of the document 5 is not permitted by the policy server 200 (NO at S107), the document processing application section 111 displays a message informing the user of the display processing being inhibited by the security policy on the display 140, terminating the display processing (S109).

The method for identifying the security level which is set for the document 5 to be subjected to the display processing on the client terminal 100 may be registered to the document DB 410 as a part of the attribute information about the document for management such that the document processing application section 111 of the client terminal 100 accesses the document DB 410 for reading the attribute value corresponding to the document ID, and directly notifying the policy server 200 of the security level to inquire thereof whether the processing is executable.

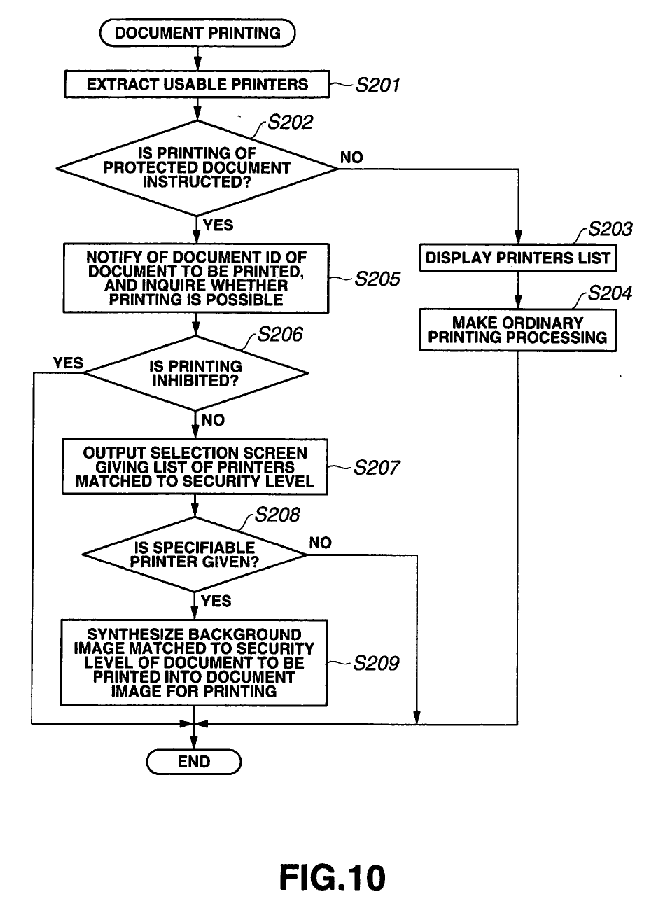

Next, the printing processing of the document on the client terminal 100 will be described with reference to the flowchart in FIG. 10.

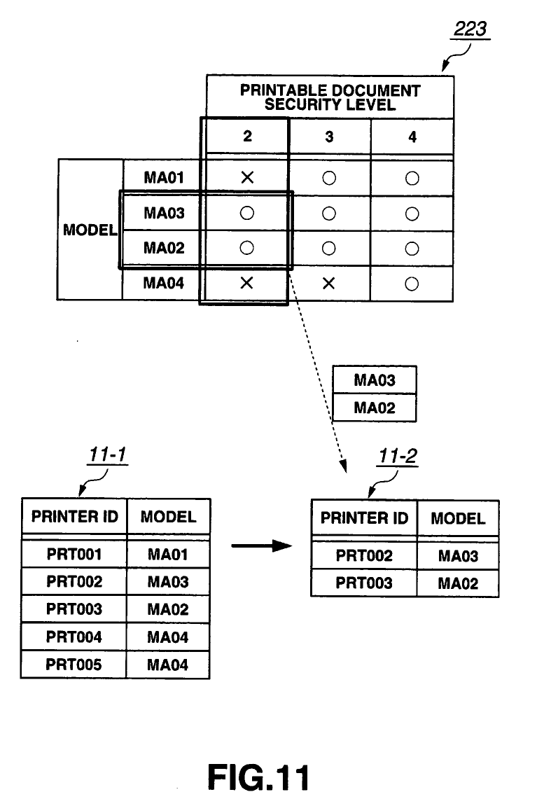

On the client terminal 100, when the document processing application section 111 detects the printing request operation for the document by the user in the input operation section 130, the document processing application section 111 extracts the entire list of usable printers 600 (for example, 11-1 in FIG. 11) (S201).

Next, the document processing application section 111 identifies the document ID of the document 5 to be printed, by making analysis of the user operation, and inquires of the policy server 200 whether the document 5 corresponding to the document ID which is identified is a document for which a security level is set for protection, by notifying it of the document ID, and the policy server 200 references the security document management information 221 with the type of processing (printing processing) and the document ID which is notified from the client terminal 100, for determining whether the document is a document for which a security level is set for protection, replying the client terminal 100 (S202).

As a result of the determination processing by the policy server 200, when the document which is specified to be printed is not a security document (NO at S202), the document processing application section 111 extracts the list of usable printers 600, and outputs the printing operation screen for user selection to the display 140 (S203) for controlling the printing of the document with the printer 600 which is specified by the user (S204).

On the other hand, when the document 5 to be printed is a document for which a security level is set for protection (YES at S202), the document processing application section 111 sends the document ID and the type of processing to the policy server 200 for inquiring thereof whether the printing of the document is possible, and the policy server 200 references the security document management information 221 with the document ID which is notified from the client terminal 100, for identifying the security level which is set for the document 5, and references the document management policy 222 with the security level which is identified, and the type of processing which is notified from the client terminal, for determining whether the printing processing is to be permitted, sending the reply data indicating the determination result to the client terminal 100 (S205).

When the document 5 is a document for which the printing processing is inhibited (YES at S206), the policy server 200 outputs a message informing the operation user of the printing processing being inhibited by the security policy, halting the printing processing.

When the document 5 is a document which is printable (NO at S206), the operation user requests of the policy server 200 the list of printer models having the printing function under the printing condition which is set for the security level of the document 5 that is determined by the security policy, and from the printers 600 which is extracted at step S201 (11-1 in FIG. 11), identifies and extracts only the printers 600 which match the printer models which is notified from the policy server 200 (11-2 in FIG. 11) (S207).

When printers 600 of the model having the printing function under the printing condition which is set for the security level are extracted (YES at S208), the printing control section 112 of the client terminal 100 outputs the printing operation screen on which the user is capable of specifying from the extracted printers 600, to the display 140, and addresses the printer 600 which is selected by the user on the printing operation screen, starting up the printer driver (the printing control section) having the function of printing the background under the printing condition defined by the security policy; preparing the printing data for synthesizing the background image defined by the security policy into the document image for printing; and outputting the prepared printing data to the printer 600 which is specified by the user (S209).

When no printer 600s having the printing function corresponding to the security level are extracted (NO at S208), the printing control section 112 displays a message informing the user of that no printers 600 with which the printing is possible are given, on the printing operation screen displayed in the display 140, halting the printing processing.

In the above exemplary embodiment, an example of configuration in which the list of printer models having the printing function under the printing condition which is set for the security level is requested from the client terminal to the policy server is given, however, a configuration other than this may be adopted. For example, the printers may be provided with information about what security level of printing condition they corresponds to, and in carrying out the printing operation, a communication may be made from the client terminal to the printers for requesting and obtaining the list of printers having the printing condition corresponding to the security level. Or, the printer driver corresponding to the respective printers on the client terminal may be provided with information about whether it corresponds to the printing condition of the security level.

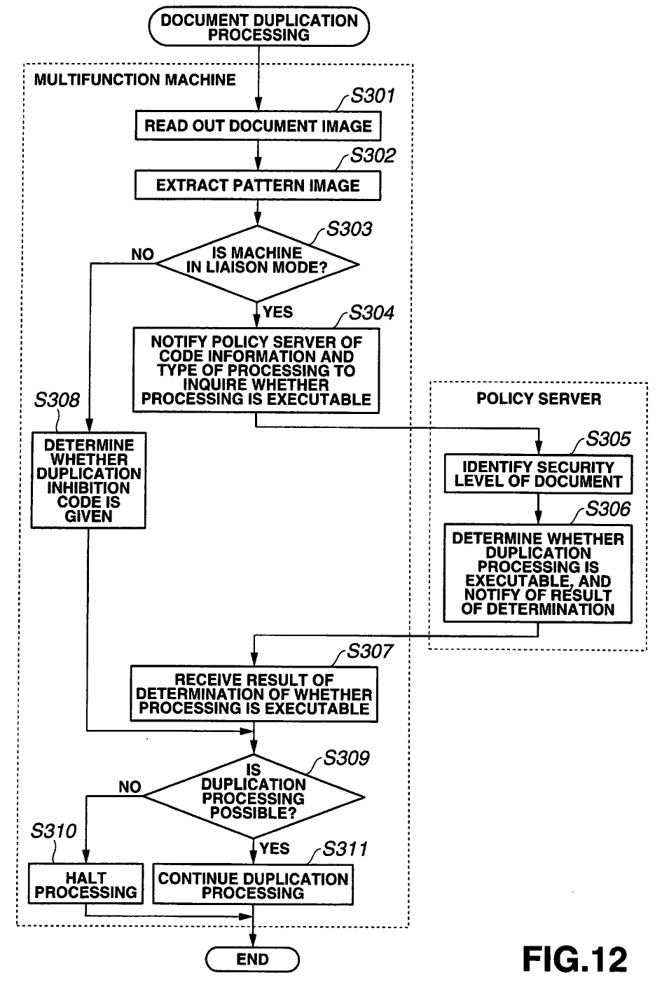

Next, an example of duplication processing of the printing document 8 with the multifunction machine 300 as shown in FIG. 1 will be described with reference to the flowchart in FIG. 12.

When the multifunction machine 300 detects the copying processing of the printing document 8, or the scan processing of the printing document 8, the multifunction machine 300 reads out the image of the printing document 8 with the image reading section 330 and the image processing section 340, and outputs the result of reading to the read image data 371 in the multifunction machine main storage section 370 (S301).

The pattern image detection section 311 carries out detection processing of the pattern image for the read image data 371, and outputs the result of detection to the multifunction machine main storage section 370 as a pattern analysis result 372 (S302).

The processing executability determination section 312 discriminates the operation mode of the document duplication processing in the multifunction machine 300 on the basis of the operation setting information which is recorded in the multifunction machine main storage section 370, discriminating whether the operation mode is an operation mode in accordance with the security policy in liaison with the policy server 200 (S303).

When the operation mode is an operation mode in liaison with the policy server 200 (YES at S303), the processing executability determination section 312 reads out the encoded information 122 (the duplication inhibition code or the document ID) which is embedded in the document, from the pattern analysis result 372, on the basis of the result of detection of the pattern image, and notifies the policy server 200 of the encoded information 122 and the type of processing (copying or image reading) for the document 5 for inquiring thereof whether duplication of the document 5 is possible (S304).

In the policy server 200, the processing executability determination section 211 references the security document management information 221 with the document ID which is recorded in the encoded information 122 which is received from the multifunction machine 300 through the policy server communication section 230 for identifying the security level of the document corresponding to the document ID (S305); references the document management policy 222 with the identified security level and the type of processing that is notified from the multifunction machine 300 for determining whether the duplication processing of the document is permitted; and sends reply data notifying the multifunction machine 300 of the determination result, the inquirer, through the policy server communication section 230 (S306).

In the multifunction machine 300, the processing executability determination section 312 determines whether the duplication processing of the document is possible, on the basis of the contents of the reply data for processing executability that is received from the policy server 200 (S307).

When the duplication processing of the document is possible (YES at S309), the processing executability determination section 312 instructs the multifunction machine main control section 310 to continue the duplication processing of the document (S311), and when the duplication processing of the document is inhibited (NO at S309), notifies the multifunction machine main control section 310 of that the duplication processing is to be halted, and the multifunction machine main control section 310 outputs a message informing the user of that the duplication processing is inhibited by the security policy, to the operation display 380, halting the duplication processing (S310).

In the determination processing at step S303, when the operation mode is not an operation mode in liaison with the policy server 200 (NO at S303), whether the pattern image in which duplication inhibition information is embedded is detected by the pattern image detection section 311 is determined on the basis of the contents of the pattern analysis result 372, and without the policy server 200 being inquired of, it is determined whether the duplication processing is possible (S308).

When the encoded information indicating duplication inhibition is detected by the pattern image detection section 311 (NO at S309), the processing executability determination section 312 notifies the multifunction machine main control section 310 of that the duplication processing of the document 5 is to be halted, and when the pattern image indicating duplication inhibition is not detected by the pattern image detection section 311 (YES at S309), the processing executability determination section 312 instructs the multifunction machine main control section 310 to continue the duplication processing (S311). In the above exemplary embodiment, it is presumed that the document processing instruction program is installed in the document processing instruction apparatus (hereinafter, to be called the computer), and on the basis of the program, the various processing sections of the computer are caused to function, however, the document processing instruction program may be supplied, being stored in a storage medium, such as a CD-ROM, or the like.

The foregoing description of the exemplary embodiment of the present invention is provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document processing system, comprising:
a document processing instruction apparatus that instructs on processing of a document;
a management apparatus that manages, corresponding to the document, a processing condition for the document; and
one or a plurality of printing apparatuses that carry out printing of the document; in which
the document processing instruction apparatus comprises:
an acquisition section that acquires the processing condition for the document related to the instruction from the management apparatus;
an extraction section that, when the instruction of the processing is instruction of printing processing, extracts, from the one or plural printing apparatuses, a printing apparatus having a function of printing under a printing condition included in the processing condition acquired by the acquisition section;
a selection receiving section that receives selection of a desired printing apparatus from the printing apparatus extracted by the extraction section; and
a printing instruction section that instructs on printing under the printing condition for the printing apparatus selected by the selection receiving section.

2. The document processing system of claim 1, wherein the printing condition includes at least two of:
a first condition for printing an image that includes encoded information for restricting the processing of the document in the entire background surface of the document, and includes hidden characters that are visualized by copying in the background of the document;
a second condition for printing an image that includes the encoded information in a part of the background of the document; and
a third condition for printing an image that includes prescribed visualized character information in the document;
the extraction section,
when the printing condition included in the processing condition acquired by the acquisition section is the first condition, extracts a printing apparatus which is capable of printing under the first condition; when the printing condition is the second condition, extracts a printing apparatus which is capable of printing under the second condition; and when the printing condition is the third condition, extracts a printing apparatus which is capable of printing under the third condition.

3. The document processing system of claim 1, wherein
the document processing instruction apparatus comprises one or a plurality of printing control sections corresponding to each of the printing apparatuses;
the extraction section extracts a printing control section corresponding to a printing apparatus that prints under the printing condition included in the processing condition; and
the selection receiving section comprises:
a display that displays a list of the printing control section extracted by the extraction section; and
a specification receiving section that receives specification of a desired printing control section in the list of the printing control section displayed by the display.

4. The document processing system of claim 2, wherein
the document processing instruction apparatus comprises one or a plurality of printing control sections corresponding to each of the printing apparatus;
the extraction section extracts a printing control section corresponding to a printing apparatus that prints under the printing condition included in the processing condition; and
the selection receiving section comprises:
a display that displays a list of the printing control section extracted by the extraction section; and
a specification receiving section that receives specification of a desired printing control section in the list of the printing control section displayed by the display.

5. The document processing system of claim 3, wherein
a printing control section corresponding to the printing apparatus that prints under a first printing condition comprises a first printing information forming section that forms printing information in which an image of the document is synthesized with an image corresponding to encoded information in the entire background surface, and in which the document is synchronized with an image corresponding to hidden characters that are visualized by copying in the background;
a printing control section corresponding to the printing apparatus that prints under a second printing condition comprises a second printing information forming section that forms printing information in which the image of the document is synthesized with an image corresponding to encoded information in a part of the background; and
a printing control section corresponding to the printing apparatus that prints under a third printing condition comprises a third printing information forming section that forms printing information in which the image of the document is synthesized with an image corresponding to visualized character information.

6. The document processing system of claim 4, wherein
a printing control section corresponding to the printing apparatus that prints under a first printing condition comprises a first printing information forming section that forms printing information in which an image of the document is synthesized with an image corresponding to encoded information in the entire background surface, and the document is synchronized with an image corresponding to hidden characters that are visualized by copying in the background;
a printing control section corresponding to the printing apparatus that prints under a second printing condition comprises a second printing information forming section that forms printing information in which the image of the document is synthesized with an image corresponding to encoded information in a part of the background; and
a printing control section corresponding to the printing apparatus that prints under a third printing condition comprises a third printing information forming section that forms printing information in which the image of the document is synthesized with an image corresponding to visualized character information.

7. The document processing system of claim 1, wherein
the document processing instruction apparatus further comprises:
an inhibition section that, when the instruction of the processing is instruction of printing processing and when the printing condition included in the processing condition acquired by the acquisition section is unconditional printing inhibition, inhibits printing of the document related to the instruction by all of the printing apparatuses.

8. The document processing system of claim 2, wherein
the document processing instruction apparatus further comprises:
an inhibition section that, when the instruction of the processing is instruction of printing processing and when the printing condition included in the processing condition acquired by the acquisition section is unconditional printing inhibition, inhibits printing of the document related to the instruction by all of the printing apparatuses.

9. The document processing system of claim 3, wherein
the document processing instruction apparatus further comprises:
an inhibition section that, when the instruction of the processing is instruction of printing processing and when the printing condition included in the processing condition acquired by the acquisition section is unconditional printing inhibition, inhibits printing of the document related to the instruction by all of the printing apparatuses.

10. The document processing system of claim 1, wherein
the document processing instruction apparatus further comprises:
a permission section that, when the instruction of the processing is instruction of printing processing and when the printing condition included in the processing condition acquired by the acquisition section is unconditional printing permission, permits printing of the document related to the instruction by all of the printing apparatuses.

11. The document processing system of claim 2, wherein
the document processing instruction apparatus further comprises:
a permission section that, when the instruction of the processing is instruction of printing processing and when the printing condition included in the processing condition acquired by the acquisition section is unconditional printing permission, permits printing of the document related to the instruction by all of the printing apparatuses.

12. The document processing system of claim 3, wherein
the document processing instruction apparatus further comprises:
a permission section that, when the instruction of the processing is instruction of printing processing and when the printing condition included in the processing condition acquired by the acquisition section is unconditional printing permission, permits printing of the document related to the instruction by all of the printing apparatuses.

13. A document processing instruction apparatus, comprising:
an acquisition section that acquires a processing condition for a document;
an extraction section that, when the instruction of processing is instruction of printing processing, extracts a printing apparatus having a function of printing under a printing condition included in the processing condition acquired by the acquisition section;
a selection receiving section that receives selection of a desired printing apparatus from the printing apparatus extracted by the extraction section; and
a printing instruction section that instructs on printing under the printing condition for the printing apparatus selected by the selection receiving section.

14. The document processing instruction apparatus of claim 13, wherein
the printing condition includes at least two of:
a first condition for printing an image that includes encoded information for restricting a processing of the document in the entire background surface of the document, and includes hidden characters that are visualized by copying in the background of the document;
a second condition for printing an image that includes encoded information in a part of the background of the document; and
a third condition for printing an image that includes prescribed visualized character information in the document;
the extraction section,
when the printing condition included in the processing condition acquired by the acquisition section is the first condition, extracts a printing apparatus which is capable of printing under the first condition; when the printing condition is the second condition, extracts a printing apparatus which is capable of printing under the second condition; and when the printing condition is the third condition, extracts a printing apparatus which is capable of printing under the third condition.

15. The document processing instruction apparatus of claim 13, further comprising one or a plurality of printing control sections corresponding to each of the printing apparatuses; wherein
the extraction section extracts a printing control section corresponding to a printing apparatus that prints under the printing condition included in the processing condition; and
the selection receiving section comprises:
a display that displays a list of the printing control section extracted by the extraction section; and
a specification receiving section that receives specification of a desired printing control section in the list of the printing control section displayed by the display.

16. The document processing instruction apparatus of claim 15, wherein
a printing control section corresponding to the printing apparatus that prints under a first printing condition comprises a first printing information forming section that forms printing information in which an image of the document is synthesized with an image corresponding to encoded information in the entire background surface, and in which the document is synchronized with an image corresponding to hidden characters that are visualized by copying in the background;
a printing control section corresponding to the printing apparatus that prints under a second printing condition comprises a second printing information forming section that forms printing information in which the image of the document is synthesized with an image corresponding to encoded information in a part of the background; and
a printing control section corresponding to the printing apparatus that prints under a third printing condition comprises a third printing information forming section that forms printing information in which the image of the document is synthesized with an image corresponding to visualized character information.

17. The document processing instruction apparatus of claim 13, further comprising:
an inhibition section that, when the instruction of the processing is instruction of printing processing and when the printing condition included in the processing condition acquired by the acquisition section is unconditional printing inhibition, inhibits printing of the document related to the instruction by all of the printing apparatuses.

18. The document processing instruction apparatus of claim 13, further comprising:
a permission section that, when the instruction of the processing is instruction of printing processing and when the printing condition included in the processing condition acquired by the acquisition section is unconditional printing permission, permits printing of the document related to the instruction by all of the printing apparatuses.

19. A computer readable recording medium storing a document processing program for causing a computer to execute a process, the process comprising:
acquiring, at the time of instruction of processing of a document, a processing condition for the document;
extracting, when the instruction of processing is instruction of printing processing, a printing apparatus having a function of printing under a printing condition included in the acquired processing condition;
receiving selection of a desired printing apparatus from the extracted printing apparatus; and
instructing on printing under the printing condition for the selected printing apparatus.

20. A computer data signal embodied in a carrier wave for enabling a computer to perform a process for document processing, the process comprising:
acquiring, at the time of instruction of processing of a document, a processing condition for the document;
extracting, when the instruction of processing is instruction of printing processing, a printing apparatus having a function of printing under a printing condition included in the acquired processing condition;
receiving selection of a desired printing apparatus from the extracted printing apparatus; and
instructing on printing under the printing condition for the selected printing apparatus.
